(19) United States
(12) Patent Application Publication
(10) Pub. No.: US 2009/0052303 A1
(43) Pub. Date: Feb. 26, 2009

(54) Objective optical element and optical head apparatus

(76) Inventors: Masaki Mukoh, Tsukuba (JP); Takeshi Shimano, Moriya (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/222,886

(22) Filed: Aug. 19, 2008

(30) Foreign Application Priority Data
Aug. 24, 2007 (JP) 2007-218455

(51) Int. Cl. G11B 7/00

(52) U.S. Cl. 369/112.01; G9B/7

(57) ABSTRACT

Two optical discs used with a laser light having the same wavelength but having different substrate thicknesses can be handled by a single optical disc apparatus and a multilayer optical disc can also be reproduced. A refractive lens unit and liquid crystal elements are provided so as to condense laser light on an optical disc having a thin substrate thickness with a first NA and to condense laser light on an optical disc having a thick substrate thickness with a second NA smaller than the first NA. The refractive lens unit is designed such that the amount of RMS wavefront aberration is minimized with respect to an intermediate substrate thickness between the two optical discs in the range of the second NA; and the RMS wavefront aberration is 0.05λ or less with respect to the substrate thickness of the optical disc in an area outside the second NA. A liquid crystal element for compatibility corrects spherical aberration due to the difference in substrate thickness between the two optical discs. A liquid crystal element for multilayer corrects spherical aberration based on layer selection of a multilayer optical disc.

### CLAIM OF PRIORITY

The present application claims priority from Japanese patent application JP 2007-218455 filed on Aug. 24, 2007, the content of which is hereby incorporated by reference into this application.

### BACKGROUND OF THE INVENTION

1. Field of the Invention

The present invention relates to an objective optical element and an optical head apparatus having the objective optical element, and more particularly, to objective optical element and an optical head apparatus adapted to optical information recording media having different substrate thicknesses and numerical apertures (NA).

2. Background Art

An optical information recording/reproducing apparatus (hereinafter referred to as “optical disc apparatus”) has been developed which optically records information on an optical information recording medium (hereinafter referred to as “optical disc”) such as a CD (Compact Disc), a DVD (Digital Versatile Disc), and an MO (Magneto Optical Disk), and reproduces the information recorded on the optical disc (hereinafter performing at least one of the recording and reproducing is referred to as recording/reproducing). Moreover, recently, an HD (High Definition-DVD) and a BD (Blu-ray Disc) have also been developed as a next-generation high-density optical disc with a larger capacity. The optical disc is structured such that an information recording layer is covered with a cover layer made of a transparent resin on a light incidence side. For example, a semiconductor laser having a wavelength of the 660 nm band as a light source and an objective lens having an NA of 0.6 to 0.65 are used for recording and/or reproducing information to and from an optical disc for a DVD. Currently, two approaches are proposed to increase the amount of information stored on one optical disc. However, these two approaches have a problem with spherical aberration introduced by an optical disc substrate, which is described below.

The first approach is to provide the information recording layer in the form of two or more layers instead of a single layer. For example, a DVD provides an optical disc having a single layer of information recording layer (hereinafter referred to as “single-layer optical disc”) whose cover thickness is 0.6 mm; while an optical disc having two information recording layers (hereinafter referred to as “multilayer optical disc”) provides a cover thickness of 0.56 mm and 0.63 mm on a light incidence side, at whose position the individual information recording layers are formed respectively. When an objective lens optimally designed to provide no aberration with respect to the single-layer optical disc is used in an optical head apparatus to conduct recording/reproducing to and from a multilayer optical disc, spherical aberration occurs due to the difference in cover thickness and a light collecting capability for the incident light to the information recording layer is deteriorated. In particular, a record type multilayer optical disc has a problem in that a deteriorated light collecting capability causes the light power density to be decreased at the time of recording and a write error occurs.

In view of this problem, SPIE Vol. 4342 p 457 (2002) “Measuring Spherical Aberration for the Dynamic Compensation of Substrate-Thickness Errors” (Reprinted from ODS 2001) proposes that a liquid crystal element should be used to correct spherical aberration due to the difference in substrate thickness for a multilayer optical disc application. As shown in FIG. 1, the optical head apparatus is characterized by including a liquid crystal phase compensation element 1 and a spherical aberration detection circuit 2 for controlling the liquid crystal phase compensation element. Except the above, the optical head apparatus has the same configuration as a conventional optical head apparatus, comprising a semiconductor laser 4, a collimate lens 5, a polarizing beam splitter 6, a ¼ wavelength plate 7, an objective lens 8, a hologram optical element (HOE) 9, a condenser lens 10 for detection, a photodetector (PD) 11, an autofocusing/tracking servo circuit 12, and an RF circuit 13, and outputs an RF signal 14 to an optical disc 3.

FIGS. 2A and 2B are schematic views of the liquid crystal phase compensation element. FIG. 2A illustrates an arrangement of electrodes; and FIG. 2B is a cross sectional view of the aberration compensation element and illustrates the change in wavefront before and after compensation. The liquid crystal phase compensation element is structured such that a liquid crystal layer 17 is sandwiched between a first substrate 15 and a second substrate 16. The liquid crystal phase compensation element can correct spherical aberration by applying a desired AC voltage to a plurality of electrodes SA1 to SA4 concentrically patterned on the first substrate 15. In the voltage drop type electrode pattern for correcting spherical aberration, the center of a low ohmic electrode and the center of a polarized electrode are aligned on the optical axis.

According to SPIE Vol. 4342 p 457 (2002) “Measuring Spherical Aberration for the Dynamic Compensation of Substrate-Thickness Errors” (Reprinted from ODS 2001), the amount of spherical aberration shown in FIG. 4 can be corrected by controlling the amount of voltage to be applied to the individual electrode using the liquid crystal phase compensation element whose specification is shown in FIG. 3. FIG. 5 shows a result of reproducing a two-layer disc having varying substrate thicknesses using this element. As shown in FIG. 5, even in the case of a substrate thickness of 0.08 mm and 0.12 mm allowing for the smallest amount of aberration compensation, the amount of spherical aberration can be reduced from 200 mλ to 50 mλ, or one-fourth (¼) the amount. FIGS. 6A and 6B show a result of observing an interference pattern on a pupil face of the objective lens to confirm that spherical aberration can be reduced by an aberration compensation element. FIG. 6A shows an interference pattern before compensation and FIG. 6B shows an interference pattern after compensation, with wavelength λ=405 nm, and NA=0.45. From FIGS. 6A and 6B, it is confirmed that the distortion of the interference fringe at the center of a pupil face of the objective lens without an aberration compensation element is excellently corrected by driving the aberration compensation element. This indicates that spherical aberration can be corrected.

However, aberration compensation by such a liquid crystal element cannot completely reduce spherical aberration to zero. This is attributable to the mechanism of a compensation technique using an area-divided liquid crystal element. For example, in FIGS. 2A and 2B, apply a certain amount of voltage to the electrodes SA1 to SA4 in an individual area, and define as a predetermined value the amount of spherical aberration to be corrected everywhere in the area, and correct the spherical aberration by a step-type function. For this reason, as shown in FIGS. 2A and 2B, the spherical aberration which can be expressed as a higher-order function cannot be completely eliminated. Of course, increasing the number of area divisions can enhance the aberration compensation accuracy, but this not only increases the number of wires for applying voltage and complicates the voltage control, but also the effect of the existence of wire itself on a wavefront cannot be ignored.

The present invention uses an RMS (root mean square) wavefront aberration as the evaluation index indicating an optical performance. The RMS wavefront aberration will be described. First, the wavefront aberration will be described. Light is a wave, and the light emitted from a semiconductor laser travels as a spherical wavefront. The wavefront aberration refers to a distortion of a concentric spherical wavefront passing through a lens. For example, assuming an ideal lens, the light passing through the ideal lens focuses on a certain single point. Here, with an attention paid not to a lens but to a wavefront, a wavefront without such a distortion is referred to as an ideal wavefront. In fact, the real wavefront experiences a deviation in comparison with the ideal wavefront. The deviation is expressed by a standard deviation, and the standard deviation between the ideal wavefront and the real wavefront is an RMS wavefront aberration. As disclosed in “Principles of Optics II” p 696 (1975) written by MaxBom and Emil Wolf translated by Tohru Kusagawa and Hidetsugu Yokota published from Tokai University Press, it is known as the ¼ wavelength law of Rayleigh in the optical design field, that if the wavefront aberration on the exit pupil does not exceed ¼, the image is not much distorted. So that the image intensity distribution adapts not only to a maximum value of the wavefront aberration but also to various shapes of wavefront (aberration types), the tolerance condition for this law needs to be determined by specifying an intensity value at a diffraction focus. With that in mind, the Marechal condition is considered. The Marechal condition says “if the intensity normalized at a diffraction focus F is 0.8 or greater, the system is corrected sufficiently”, which is equivalent by saying “the standard deviation (RMS wavefront aberration) of departure between a wavefront and a reference spherical surface centered on the diffraction focus is the value λ/14 or less”. The optical head apparatus suffers alignment errors in assembling not only the objective optical element but also other optical elements and aberration in an optical element unit. In view of this, the optical head apparatus is designed so as to satisfy the Marechal condition as the entire optical head apparatus, which applies to the number of area divisions of the liquid crystal phase compensation element. In fact, it is common to reduce the number of area divisions as much as possible by considering the manufacturing costs, ease of control, and the Marechal condition.

The second approach is to form a small recording mark in order to write as much information as possible to the information recording layer. This approach can be implemented by using a laser with a short wavelength and an objective lens with a large NA. Specifically, in order to enhance the recording density of an optical disc, the BD standard proposes a semiconductor laser having a wavelength of 405 nm band as the light source, an objective lens having an NA of 0.85 and an optical disc having a cover thickness of 0.1 mm. Around the same time, the HD standard proposes a semiconductor laser having a wavelength of 405 nm band which is the same as in the BD standard, an objective lens having an NA of 0.65 and an optical disc having a cover thickness of 0.6 mm which is the same as in the DVD. In order to support the above described two different standards, the difference in spherical aberration therebetween needs to be corrected.

An optical disc stores audio and software content mainly as a distribution medium, an optical disc apparatus for reproducing the optical disc is required especially to be backward compatible with one capable reproducing the existing optical discs. Although various types of optical discs such as a BD, an HD, a DVD, and a CD differ in thickness from the substrate surface to a recording layer, wavelength of the laser used for recording and reproducing, NA of the objective lens, an optical disc apparatus supporting a plurality of optical discs has been developed.

For the problem with the second approach, for example, JP Patent Publication (Kokai) No. 10-172151A (1998) discloses how an optical pickup apparatus implements reading and writing a signal to and from a conventionally popular CD and DVD. According to JP Patent Publication (Kokai) No. 10-172151A (1998), the two objective lens, one for a CD and one for a DVD, are supported by axially slidable support means and the objective lens are switched therebetween by rotating the support means around the axis. For a BD/HD compatible lens, it is possible to design a BD/HD compatible lens having a diffraction grating structure based on the same design method as for a CD/DVD compatible lens as disclosed by JP Patent Publication (Kokai) No. 7-98431A (1995). Further, JP Patent Publication (Kokai) No. 2007-26540A discloses how to implement a BD/HD compatible lens by a combination of spherical aberration compensation using an objective lens for a BD or an HD and a liquid crystal element.

The present specification defines a substrate thickness as “a thickness from the substrate surface to a recording layer”. When a two-layer BD disc defined as above is considered, the same disc has varying substrate thicknesses. When an attention is paid to a surface-near side viewed from a light incident side, the substrate thickness is 0.0975 μm, and when an attention is paid to a surface-far side, the substrate thickness is 0.1 μm. This implies that even if the same disc is reproduced, different amount of spherical aberration needs to be corrected to reproduce a different layer.

### SUMMARY OF THE INVENTION

According to JP Patent Publication (Kokai) No. 10-172151A (1998), different objective lenses are used by switching one for a DVD and one for a CD, thereby increasing the weight of the optical head. For this reason, further improvement is required in terms of mechanical reliability and productivity. The same design method as for a CD/DVD compatible lens as disclosed in JP Patent Publication (Kokai) No. 7-98431A (1995) can be used to design a BD/HD compatible lens, but for a diffraction grating in the same wavelength, the entire light component is designed to be shared between the BD and the HD. Therefore, the individual light use efficiency is decreased and thus the record reproduction performance is decreased. According to JP Patent Publication (Kokai) No. 2007-26540A, the entire light is used, and thus, theoretically, as high a light use efficiency as a BD-specific and a HD-specific objective lens can be expected. However, this method involves a large amount of spherical aberration required to be corrected by a liquid crystal element and thus an increase in size of the liquid crystal element or the drive voltage is inevitable. In addition, the liquid crystal element has such an inherent problem that phase compensation is carried out only in a stepwise manner, and thus the larger the spherical aberration, the less the accuracy.

In view of the above circumstances, the present invention has been made, and an object of the present invention is to provide an objective optical element and an optical head apparatus capable of reducing the amount of voltage necessary for driving a liquid crystal element and performing aberration compensation with a good accuracy as well as enabling an optical disc apparatus to support two different kinds of optical discs having different substrate thicknesses such as an HD and a BD using a laser light having the same wavelength and reproducing a multilayer optical disc.

An objective optical element in accordance with the present invention condenses laser light on a first optical information recording medium having a first substrate thickness with a first NA, and condenses the laser light on a second optical information recording medium having a second substrate thickness thicker than the first substrate thickness with a second NA smaller than the first NA; comprising a refractive lens unit and an aberration compensation element unit. The refractive lens unit is designed such that the amount of RMS wavefront aberration is minimized with respect to a specific substrate thickness between the first substrate thickness and the second substrate thickness in the range of the second NA; and the RMS wavefront aberration is 0.05λ or less with respect to the first substrate thickness in an annular region outside the second NA and inside the first NA.

The amount of RMS wavefront aberration 0.05λ is determined on the basis of a value of a residual aberration which cannot be corrected even by operating the aberration compensation element unit when one of the first substrate thickness and the second substrate thickness is selected in an area designed such that the amount of RMS wavefront aberration is minimized with respect to a specific substrate thickness between the first substrate thickness and the second substrate thickness. The above residual aberration is attributable to a structure of the aberration compensation element. More specifically, the wavefront subject to aberration compensation is a smooth curve, while the liquid crystal element applies a certain amount of voltage to the individual areas to perform stepped compensation. In addition, in order to apply different voltage to between individual areas, the individual areas need to be separated so as not to be in electrical contact with a transparent electrode. In view of such a characteristic of the element, it is difficult to completely reduce the amount of RMS wavefront aberration to zero, and thus the present invention uses a value actually confirmed in SPIE Vol. 4342 p 457 (2002) “Measuring Spherical Aberration for the Dynamic Compensation of Substrate-Thickness Errors” (Reprinted from ODS 2001). Obviously, it is possible to further improve the residual aberration by improving the process of fabricating the aberration compensation element, which is desirable in terms of optical property. However, the value of 0.05λ satisfies the above described Marechal condition λ/14 or less, and there is no problem as a compatible objective element.

The aberration compensation element unit has a structure in which a liquid crystal is sandwiched between a first transparent substrate and a second transparent substrate. At least the first transparent substrate is provided with a transparent electrode and the transparent electrode has an electrode arrangement capable of correcting to ¼ or less the RMS wavefront aberration when the refractive lens unit condenses light on the first optical information recording medium and the second optical information recording medium by applying voltage in the second NA range to the respective optical information recording medium.

The transparent electrode formed on the first transparent substrate is a concentric ring shaped pattern electrode formed in an area corresponding to the second NA. The polarity of an effective value of a voltage to be applied to the transparent electrode is reversed between the time when laser light is condensed on the first optical information recording medium and the time when laser light is condensed on the second optical information recording medium.

The first optical information recording medium may be a multilayer recording medium. In this case, the second transparent substrate of the aberration compensation element unit is configured to be provided with a transparent electrode having an electrode arrangement capable of correcting to ¼ or less the RMS wavefront aberration when laser light is condensed on a layer other than a basic recording layer of the first optical information recording medium by applying a voltage in the first NA range. Specifically, the transparent electrode formed on the first transparent substrate is a concentric ring shaped pattern electrode formed in an area corresponding to the second NA, and the transparent electrode formed on the second transparent substrate is a concentric ring shaped pattern electrode formed in an area corresponding to the first NA.

Alternatively, when the first optical information recording medium is a multilayer recording medium, the electrode arrangement of the transparent substrate formed on the first transparent substrate of the aberration compensation element unit may be configured inside or outside the area corresponding to the second NA as described below. The area corresponding to the second NA may be configured to have an electrode arrangement capable of correcting to ¼ or less the RMS wavefront aberration when laser light is condensed on the individual recording layers of the first optical information recording medium and the RMS wavefront aberration when laser light is condensed on the second optical information recording medium by applying a voltage; and the an annular region corresponding to the outside of the second NA and the inside of the first NA may be configured to have an electrode arrangement capable of correcting to ¼ or less the RMS wavefront aberration when the laser light is condensed on the individual recording layers of the first optical information recording medium by applying a voltage.

The present invention can provide an objective optical element and an optical head apparatus capable of recording and reproducing information to and from the two different kinds of optical discs having different substrate thicknesses such as an HD and a BD using a light beam having the same wavelength and further capable of recording and reproducing information to and from a multilayer optical disc.

In addition, the objective optical element and the optical head apparatus in accordance with the present invention can provide backward compatibility to a DVD and a CD by combining with existing techniques.

### BRIEF DESCRIPTION OF THE DRAWINGS

FIG. 1 is a schematic view showing a configuration of a conventional optical head apparatus using an aberration compensation element.

FIGS. 2A and 2B are schematic views showing a configuration of a conventional aberration compensation element.

FIG. 3 is a table showing the specifications of the conventional aberration compensation element.

FIG. 4 is a drawing showing the correspondence between a voltage applied to the conventional aberration compensation element and a target substrate thickness.

FIG. 5 is a drawing showing the amount of spherical aberration reduced by the conventional aberration compensation element.

FIGS. 6A and 6B are drawings showing the interference patterns indicating that spherical aberration is reduced by the conventional aberration compensation element.

FIGS. 7A to 7C are explanatory drawings explaining the reproduction of a single-layer HD, a single-layer BD, a two-layer/multilayer BD in accordance with the present invention.

FIG. 8 is a schematic view showing a configuration of an objective optical element in accordance with a first embodiment of the present invention.

FIG. 9 is a table showing the specifications of an aberration compensation element unit in accordance with the embodiment of the present invention.

FIG. 10 is a table showing the specifications of a phase shifter in accordance with the embodiment of the present invention.

FIGS. 11A to 11C are schematic views showing a configuration of the aberration compensation element unit in accordance with the first embodiment of the present invention.

FIG. 12 is a schematic view showing a configuration of an optical head apparatus in accordance with the first embodiment of the present invention.

FIG. 13 is a schematic view showing a configuration of a liquid crystal drive circuit for an aberration compensation element unit in accordance with the first embodiment of the present invention.

FIGS. 14A to 14C are drawings showing a change in wavefront aberration shape and an explanatory drawing explaining the amount of wavefront aberration corrected by driving the aberration compensation element in accordance with the first embodiment of the present invention.

FIGS. 15A and 15B are explanatory drawings explaining the spherical aberration shape at reproduction of a BD and an HD by the conventional objective optical element and the present invention.

FIGS. 16A and 16B are explanatory drawings explaining the spherical aberration shape at reproduction of the BD and the HD by the conventional technique and the present invention.

FIG. 17 is a schematic view showing a configuration of an objective optical element in accordance with a second embodiment of the present invention.

FIGS. 18A and 18B are schematic views showing a configuration of an aberration compensation element unit in accordance with the second embodiment of the present invention.

FIG. 19 is a schematic view showing a configuration of an optical head apparatus in accordance with the second embodiment of the present invention.

FIG. 20 is a schematic view showing a configuration of a liquid crystal drive circuit for the aberration compensation element unit in accordance with the second embodiment of the present invention.

### DESCRIPTION OF SYMBOLS

1 Liquid crystal phase compensation element
2 Spherical aberration detection circuit
3 Optical disc
4 Semiconductor laser
5 Collimate lens
6 Polarizing beam splitter
7 ¼ wavelength plate
8 Objective lens
9 Hologram optical element
10 Condenser lens for detection
11 Photodetector
12 Autofocusing/tracking servo circuit
13 RF circuit
14 RF signal
15 First substrate
16 Second substrate
17 Liquid crystal layer
18 Refractive lens unit
19 Aberration compensation element unit (forward path)
20 Aberration compensation element unit (backward path)
21 Electrochromic aperture limiting element
22 CD compatible wavelength selection phase shifter
23 DVD compatible wavelength selection phase shifter
24 Aberration compensation objective optical element
25 Combination objective lens unit 1
26 Combination objective lens unit 2
27 Aberration compensation element unit with electrode arrangement integrally including multilayer BD compensation and BD/HD compatibility (forward path)
28 Aberration compensation element unit with electrode arrangement integrally including multilayer BD compensation and BD/HD compatibility (backward path)

### DETAILED DESCRIPTION OF THE PREFERRED EMBODIMENTS

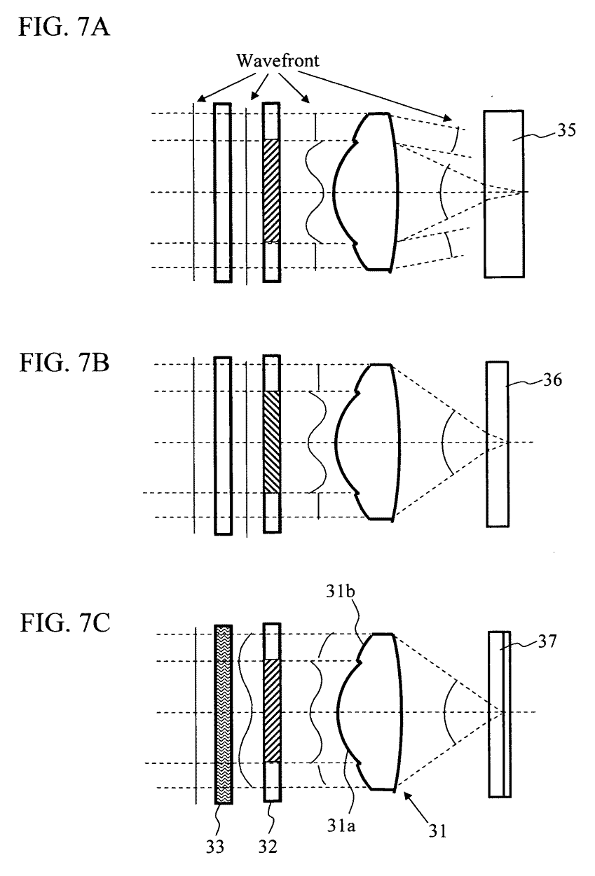

Methods for single-layer HD reproduction, single-layer BD reproduction, and two-layer/multilayer BD reproduction using the objective optical element in accordance with the present invention will be described with reference to FIGS. 7A to 7C by taking an example of an HD and a BD as two different kinds of optical discs having different substrate thicknesses respectively. FIG. 7A is an explanatory drawing for single-layer HD reproduction; FIG. 7B is an explanatory drawing for single-layer BD reproduction; and FIG. 7C is an explanatory drawing for multilayer BD reproduction.

The objective optical element in accordance with the present invention is provided with an objective lens 31 and liquid crystal elements 32 and 33 for aberration compensation as a main component thereof. The objective lens 31 includes a center portion 31a corresponding to an NA of 0.65 and an annular-shaped outer peripheral portion 31b outside thereof. The center portion 31a is designed to eliminate spherical aberration with respect to a specified substrate thickness between a BD substrate thickness and an HD substrate thickness. The outer peripheral portion 31b is designed to eliminate spherical aberration with respect to a BD substrate thickness of 0.1 mm. The liquid crystal element 32 is a BD/HD compatible element for correcting spherical aberration generated by the difference in substrate thickness between the BD and the HD, and corrects a wavefront of an area of the objective lens 31 corresponding to an NA of 0.65. The liquid crystal element 33 is a BD multilayer element for correcting spherical aberration based on a layer selection of the BD multilayer optical disc. When a recording layer corresponding to the recording layer of a single-layer BD is assumed to be a basic recording layer, the liquid crystal element 33 is used to conduct recording/reproducing to and from a layer other than the basic recording layer. It should be noted that the liquid crystal elements 32 and 33 are shown separately by two elements in the figure, but are not necessarily separated structurally.

As shown in FIG. 7A, when a single-layer HD 35 is reproduced, a voltage is applied to the liquid crystal element 32 to correct spherical aberration generated by the objective lens 31. At this time, the HD 35 with a smaller NA than for the BD does not use light of the outer peripheral portion 31b of the lens. Since the objective lens 31 is designed such that the outer peripheral portion 31b thereof conforms to the substrate thickness of the BD, the spherical aberration is greatly increased at the HD reproduction, and thus, as shown in the figure, an image is not formed on the HD disc 35. In view of the BD/HD compatibility, this implies that aperture limiting is performed at the HD reproduction depending on the spherical aberration of the lens.

As shown in FIG. 7B, when a BD 36 is reproduced, a voltage is applied to the liquid crystal element 32 in the same way as at the HD reproduction. However, as opposed at the HD reproduction, the voltage direction, or the sign of an effective value of the AC voltage is reversed. This is because the objective lens 31 is set such that the center portion 31a thereof adapts to an intermediate value between the BD and the HD, and when the substrate thickness to be corrected is considered by adding a positive or a negative sign, the sign is reversed between the BD and the HD. This device can minimize the amount of applied voltage needed to drive the liquid crystal. The light of the entire objective lens 31 is used for BD reproduction. The spherical aberration of the light passing through the center portion of the lens is corrected by the liquid crystal element 32; and since the outer peripheral portion 31b of the lens is designed to adapt to the substrate thickness of the BD from the beginning, the light passing there through does not generate spherical aberration. Accordingly, the light is irradiated on the BD 36 with the spherical aberration corrected.

As shown in FIG. 7C, when a multilayer BD 37 is reproduced, a voltage is applied to not only the liquid crystal element 32 but also the liquid crystal element 33. Applying a voltage to the liquid crystal element 33 allows spherical aberration to be corrected according to the individual layer spacing of the multilayer BD.

The objective optical element or the optical head apparatus in accordance with the present invention can provide low voltage drive, and spherical aberration with a high accuracy in comparison with a conventional aberration compensation element, can be compatible with BD/HD and can support a multilayer BD disc. Hereinafter, the present invention will be described in more detail with reference to embodiments.

### First Embodiment

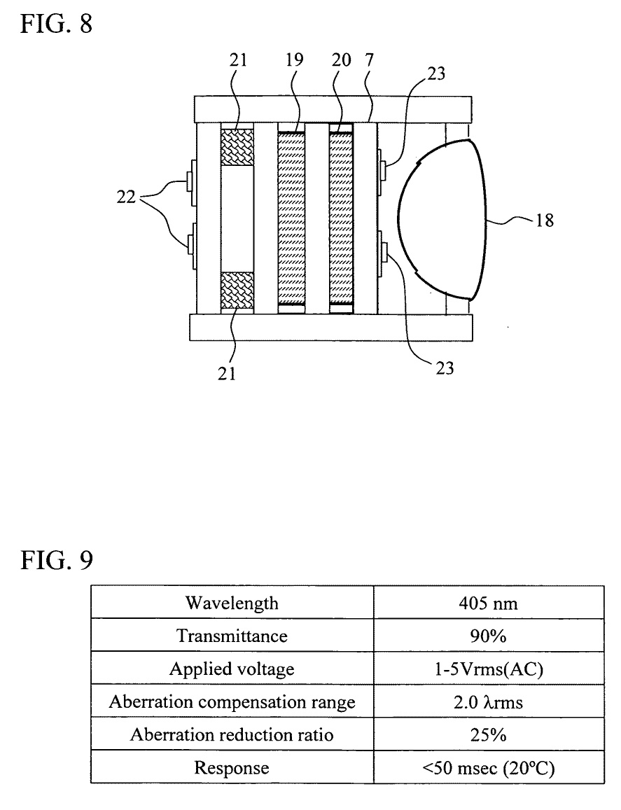

FIG. 8 is a schematic view showing an example of the objective optical element in accordance with the present invention.

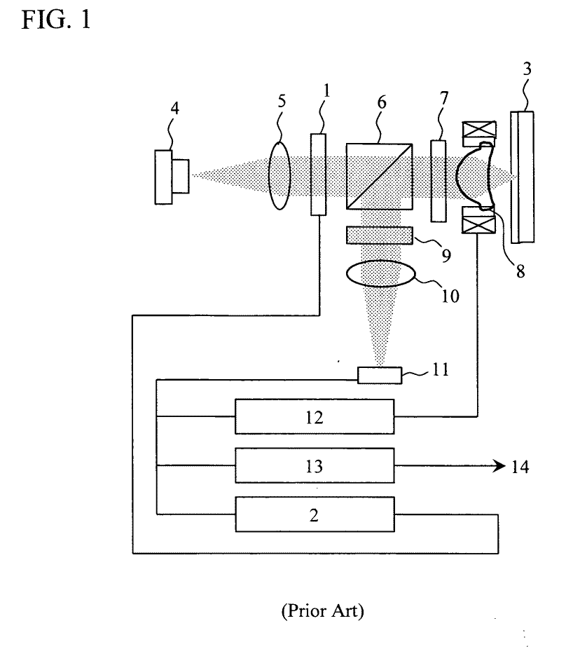

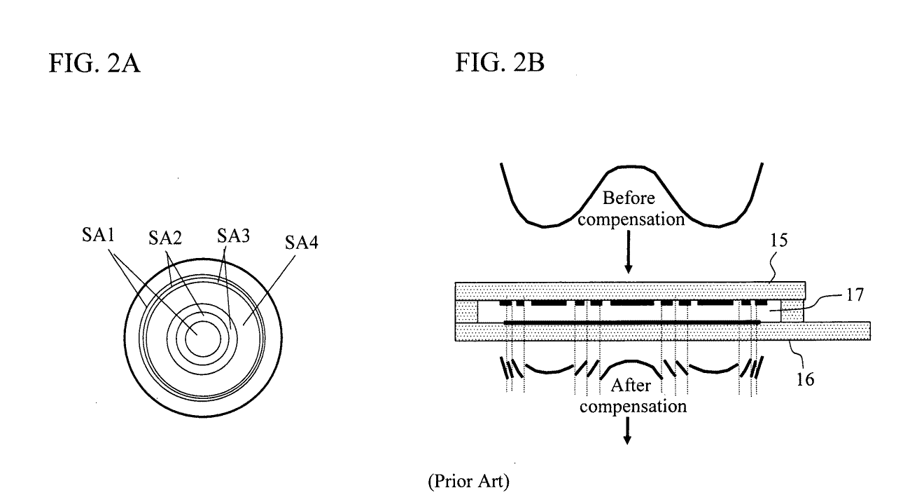

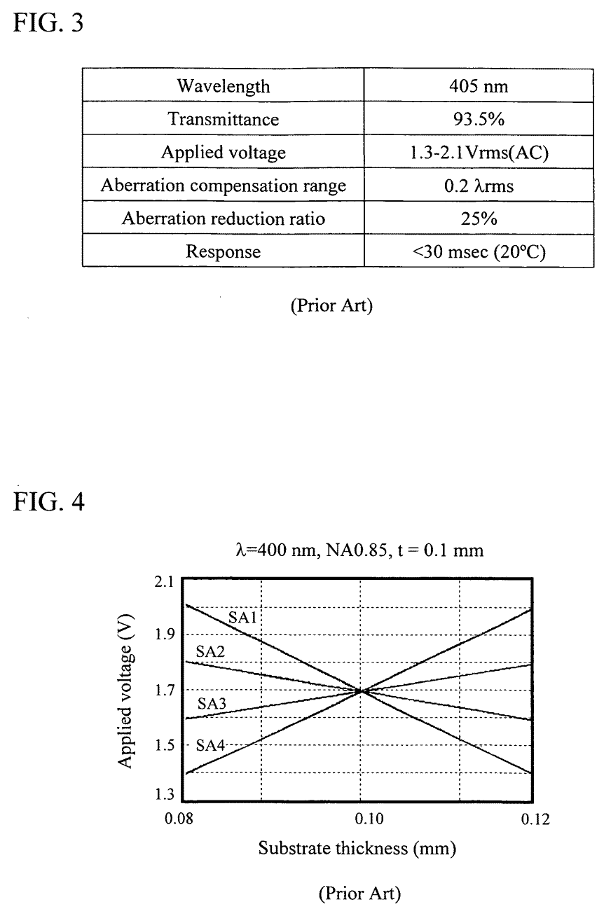

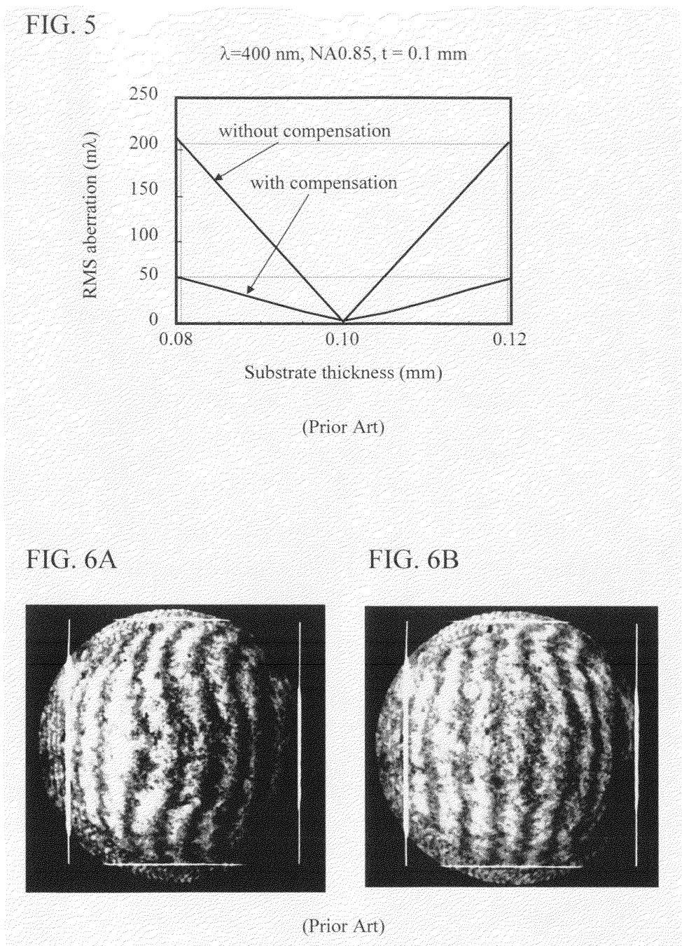

In the present invention, the path traced until the emitted laser light is condensed by the objective optical element on a recording surface of the disc is defined as a forward path; and the path traced until the laser light reflected from the recording surface enters the detector is defined as a backward path. The spherical aberration compensation disclosed in SPIE Vol. 4342 p 457 (2002) “Measuring Spherical Aberration for the Dynamic Compensation of Substrate-Thickness Errors” (Reprinted from ODS 2001) can correct only the forward path spherical aberration shown in FIG. 1. Hereinafter, the reason will be described.

The optical disc uses the property of light where linear polarized light incident to the recording surface is rotated by 90° and thus the optical system is simplified by using a polarizing beam splitter 6. Specifically, linear polarized light emitted from the semiconductor laser 4 passes through polarizing beam splitter 6 and when reflected by the optical disc 3, the direction of the linear polarized light is rotated. Then, the reflected light is reflected by the polarizing beam splitter 6 and enters the photodetector 11. Such an arrangement of the polarizing beam splitter 6 only allows a common portion to be set for both the forward path and the backward path, and thereby the optical system can be reduced in size. In FIG. 1, since laser light passes the liquid crystal phase compensation element 1 before passing the polarizing beam splitter 6, spherical aberration after the laser light is reflected by the optical disc 3 or on the backward path is not corrected.

In order to correct spherical aberration on both the forward path and the backward path, the liquid crystal phase compensation element needs to be provided between the polarizing beam splitter 6 and the optical disc 3. This means that the liquid crystal phase compensation element is provided together with the objective lens 8 in a moving part of the optical pickup apparatus. Since the liquid crystal phase compensation element has an optical property which allows a liquid crystal only to act on polarized light in a single direction, different liquid crystal phase compensation elements are required on the forward path and the backward path. An optical system satisfying the above condition is shown in FIG. 8. The detail of the FIG. 8 will be described below.

As shown in FIG. 8, the objective optical element includes a ¼ wavelength plate 7, a refractive lens unit 18, an aberration compensation element unit (forward) 19, an aberration compensation element unit (backward) 20, an electrochromic aperture limiting element 21, a CD compatible wavelength selection phase shifter 22, and a DVD compatible wavelength selection phase shifter 23. The forward and backward aberration compensation element units 19 and 20 are different only in direction of the liquid crystal alignment by 90°, but are the same in structure and the like except this. Such a configuration enables spherical aberration to be compensated for both linear polarized light beams having different directions before and after incident to an optical disc. The specifications of the aberration compensation element unit (forward path) and the aberration compensation element unit (backward path) are shown in FIG. 9; and the detailed structure thereof is shown in FIGS. 11A to 11C. The structure shown in FIGS. 11A to 11C will be described later.

The refractive lens unit 18 is designed in shape so as to act as an objective element for different substrate thicknesses on the center portion of an area corresponding to an NA of 0.65 and the outer peripheral portion. When an attention is paid to a BD and an HD, the outer peripheral portion of the refractive lens unit 18 is designed so as to eliminate spherical aberration with respect to the BD substrate thickness of 0.1 mm since the area needs only to pass BD light with a large NA. On the contrary, the center portion of the refractive lens unit 18 is designed so as to eliminate spherical aberration with respect to a certain substrate thickness between the BD substrate thickness and the HD substrate thickness. According to the present embodiment, the center portion of the refractive lens unit 18 is designed so as to eliminate spherical aberration with respect to an intermediate substrate thickness of 0.35 mm between the BD substrate thickness and the HD substrate thickness. It should be noted that since the BD and HD are different in not only substrate thickness but also NA, the use of an intermediate substrate thickness of 0.35 mm between the BD substrate thickness and the HD substrate thickness does not necessarily reduce the amount of spherical aberration to half. Although the amount of spherical aberration cannot be exactly reduced to half, the amount of compensation by the aberration compensation element unit can be adjusted by the amount of applied voltage. Therefore, as a rough number, a value of 0.35 mm which is an intermediate value in substrate thickness between a single-layer BD disc and a single-layer HD disc is set. Of course, the present invention is not limited to the above 0.35 mm. The current standard specifies that the substrate thickness of a two-layer BD is 0.085 mm and the substrate thickness of an HD is 0.6 mm. The use of a substrate thickness between the above figures allows the voltage direction to be reversed in sign at the time of reproducing a BD and an HD. It is desirable to set the substrate thickness to suite each individual application of the optical disc drive to be used. If the use frequency of a BD and an HD is almost the same, the substrate thickness should be set to an intermediate value therebetween; and if a BD is more often used than the other, the substrate thickness should be set to a value closer to the BD.

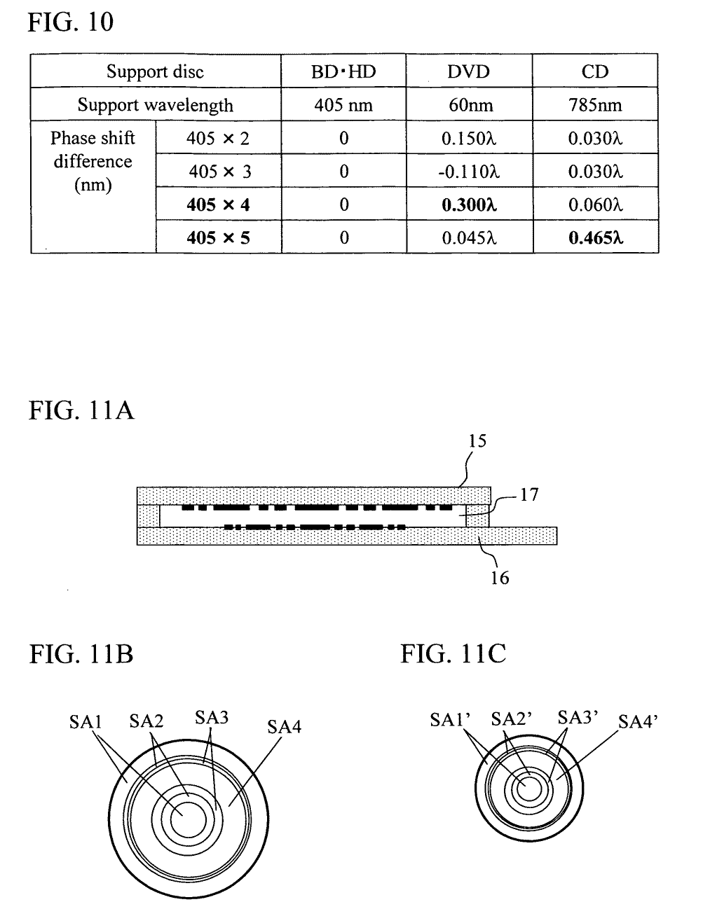

If an emphasis is placed on a BD having a single laser wavelength of 405 nm and HD compatibility only, the CD compatible wavelength selection phase shifter 22 and the DVD compatible wavelength selection phase shifter 23 are not required, but the present embodiment uses them in order to provide not only BD/HD compatibility but also DVD/CD compatibility simply by adding existing phase shifters. The phase shifter uses a shift difference in size of an integer multiple of a predetermined wavelength in order to provide wavelength selection. FIG. 10 shows phase shift differences required as the phase shifter and optical path length for each wavelength. As understood from FIG. 10, a shift difference being an integer multiple of a wavelength of 405 nm of light used for a BD/HD cannot be seen by light having a wavelength of 405 nm, but, a certain optical path length, can be seen by light having a different wavelength, for example, light of 660 nm used by a DVD or light of 785 nm used by a CD. With that in mind, an “integer” is skillfully selected from among an integer multiple of 405 nm to design a shift difference which does not act on light having a wavelength of 405 nm and 660 nm, but act only on light having a wavelength of 785 nm and a shift difference which does not act on light having a wavelength of 405 nm and 785 nm, but act only on light having a wavelength of 660 nm. For the phase shift difference for the former, 0.405×5 nm (=2.25 μm); and for the phase shift difference for the latter, 0.405×4 nm (=1.80 μm). These phase shifter patterns are formed by forming SiO₂ by a general evaporation method or a sputtering method, and performing photolithography and etching processes on the transparent film.

The present embodiment uses the electrochromic aperture limiting element 21 to support four different NAs: BD, HD, DVD, and CD. The electrochromic aperture limiting element 21 is formed of a lower transparent electrode, an electrochromic film, a solid-state electrolyte membrane, and an upper transparent electrode. When a voltage is applied to between the upper and lower transparent electrodes, H⁺ (proton) or a positive ion inside the solid-state electrolyte membrane enters the electrochromic film, which changes the chemical structure of an electrochromic material to be pigmented. At this time, a patterning is performed such that there is a transparent electrode only in an NA limiting area. As a result, only the portion to which a voltage is applied absorbs light not to pass unnecessary light. In other words, the portion can act as an NA limiting method. Alternatively, an aperture stop capable of limiting the NA by a mechanical operation other than the electrochromic aperture limiting element 21 may be used. The aperture stop has been used in an optical imaging element such as a camera and the like.

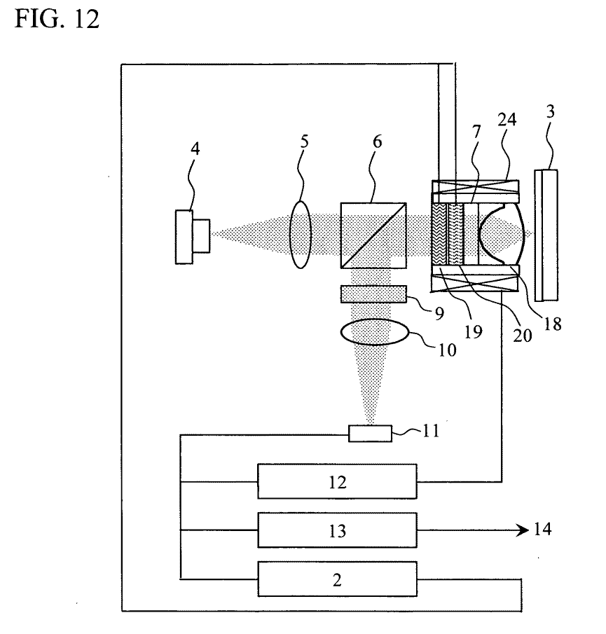

FIGS. 11A to 11C are schematic views showing a configuration of the aberration compensation element unit in accordance with the present embodiment. FIG. 12 is a schematic view showing a configuration of an optical head apparatus in accordance with the present embodiment. Hereinafter, for simplicity of explanation, an example of the configuration in which the electrode has two aberration compensation patterns in order to correct different wavefront aberrations, but another configuration having three or more aberration compensation patterns by adding a new aberration compensation pattern in order to correct still other different aberration may be configured in the same way.

FIG. 11A is a schematic cross section of the aberration compensation element of the present embodiment; FIG. 11B is a schematic layout of a multilayer BD compensation electrode; and FIG. 11C is a schematic layout of a BD/HD compatible electrode. As shown in FIG. 11A, the aberration compensation element in accordance with the present embodiment includes a first substrate 15, a second substrate 16, and a liquid crystal layer 17 which is provided in a space formed via a seal (not shown) including a spacer sandwiched therebetween. As shown in FIG. 11B, transparent electrodes SA1, SA2, SA3, and SA4 having a concentric ring shaped pattern are formed on the first substrate 15 to correct spherical aberration of the first multilayer BD optical disc. As shown in FIG. 11C, transparent electrodes SA1′, SA2′, SA3′, and SA4′ each having a different concentric ring shaped pattern are formed on the second substrate 16 to correct spherical aberration due to the difference in the second BD/HD compatible substrate thickness. The spherical aberration can be corrected by applying a desired AC voltage to the concentric ring shaped transparent electrodes SA1, SA2, SA3, and SA4, and transparent electrodes SA1′, SA2′, SA3′, and SA4′.

These transparent electrode patterns are formed by forming indium tin oxide (ITO) as a transparent conductive film by a general evaporation method or a sputtering method and performing photolithography and etching processes on the transparent electrode film. The present embodiment uses ITO representative as a transparent electrode film material, but another material such as tin zinc oxide (ZnO) and the like which has recently been considered as a transparent electrode film material may be used.

FIG. 12 is a schematic view showing a configuration of an optical head apparatus. In FIG. 12, reference numeral 3 denotes a BD or HD optical disc. The aberration compensation objective optical element 24 integrally includes the refractive lens unit 18, the aberration compensation element unit (forward path) 19, the aberration compensation element unit (backward path) 20, and the ¼ wavelength plate 7, as shown in FIG. 8, as well as an electrochromic aperture limiting element, a CD compatible wavelength selection phase shifter, a DVD compatible wavelength selection phase shifter, and an actuator (not shown). The aberration compensation objective optical element 24 includes a mechanism for moving the objective optical element at a high speed and with a high accuracy, and moves along the two axes in an optical axis direction and in a direction perpendicular to the optical axis (i.e., in an inner peripheral direction and in an outer peripheral direction of the optical disc 3) by driving the actuator to perform positional control of the light spot from the objective lens to the optical disc 3.

The light beam for an HD and a BD emitted by the semiconductor laser 4 passes through the collimate lens 5, the polarizing beam splitter (PBS) 6, and the aberration compensation objective optical element 24 and then is irradiated on the optical disc 3. The light beam reflected by the optical disc 3 is reflected by the polarizing beam splitter 6; and is separated into an RF signal component and an autofocusing/tracking servo signal component by the hologram optical element; and is detected as an electrical signal through the condenser lens 10 for detection by the photodetector 11. The electrical circuit is configured with three circuits: the spherical aberration detection circuit 2, the autofocusing/tracking servo circuit 12, and the RF circuit 13. An output signal of the autofocusing/tracking servo circuit 12 is used to perform the positional control of the optical spot from the aberration compensation objective optical element 24 to the optical disc 3 by operating the actuator. An output signal of the spherical aberration detection circuit 2 is used to set the voltage value for driving the liquid crystal of the aberration compensation element unit (forward path) 19 and the aberration compensation element unit (backward path) 20 included in the aberration compensation objective optical element 24. After the servo operation and the spherical aberration compensation are performed, the RF signal 14 is outputted from the RF circuit 13.

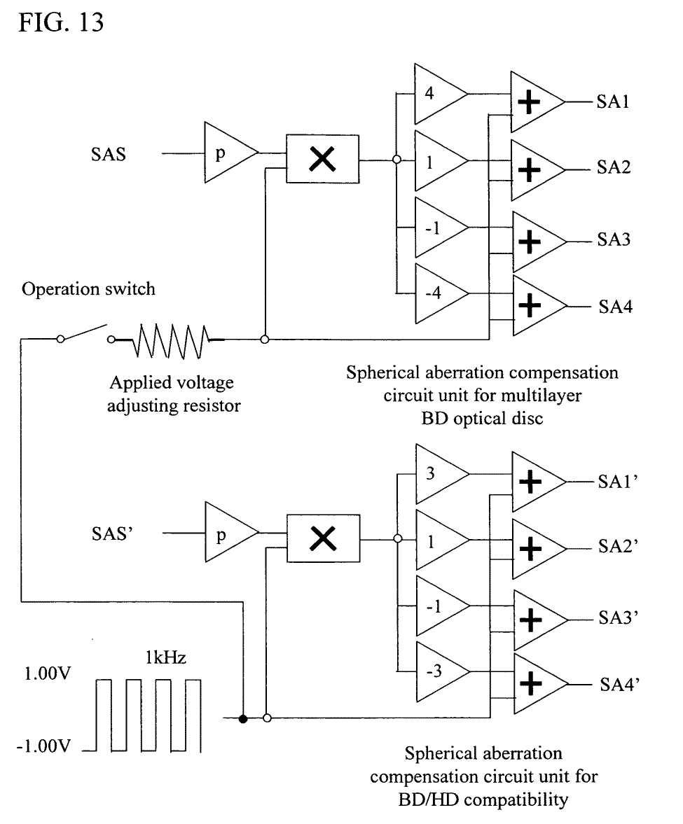

FIG. 13 is a configuration example of a liquid crystal drive circuit for the aberration compensation element unit. The liquid crystal drive circuit is configured to be able to apply a voltage to the pattern electrodes SA1, SA2, SA3, and SA4 for correcting spherical aberration generated by the multilayer BD optical disc formed on the first substrate 15 and the pattern electrodes SA1′, SA2′, SA3′, and SA4′ for correcting spherical aberration generated due to BD/HD compatibility formed on the second substrate 16. There is no need to provide a power source separately to the spherical aberration compensation circuit unit for multilayer BD optical disc and the spherical aberration compensation circuit unit for BD/HD compatibility, but the use of an applied voltage adjusting resistor enables a single power source driving. Further, the weighting of an adding circuit provided inside the spherical aberration compensation circuit unit for multilayer optical disc and the spherical aberration compensation circuit unit for BD/HD compatibility can be set freely.

The present embodiment pays an attention to a sharp inclination of wavefront aberration with a large NA in the pattern electrode existing in an outer peripheral portion of the objective lens unit for spherical aberration compensation for a multilayer optical disc. This implies that the inclination of the voltage value required to be applied to the outer peripheral portion of the objective lens is larger than that for the central region thereof. For this reason, adjustment is made so as to increase the weight of the internal adding circuit in comparison with the spherical aberration compensation pattern electrode existing in the outer peripheral portion and the center portion of the objective lens unit for BD/HD compatibility. This allows spherical aberration compensation with a higher accuracy. In the present embodiment, a maximum of ±3V rms of AC voltage needs to be applied for spherical aberration compensation for BD/HD compatibility; and a maximum of ±4V rms of AC voltage needs to be applied for spherical aberration compensation for a multilayer BD optical disc. According to the present embodiment, as shown in FIG. 13, +3V rms, +1V rms, −1V rms, −3V rms of AC voltage are applied to the concentric ring shaped electrode areas SA1′, SA2′, SA3′, and SA4′, respectively.

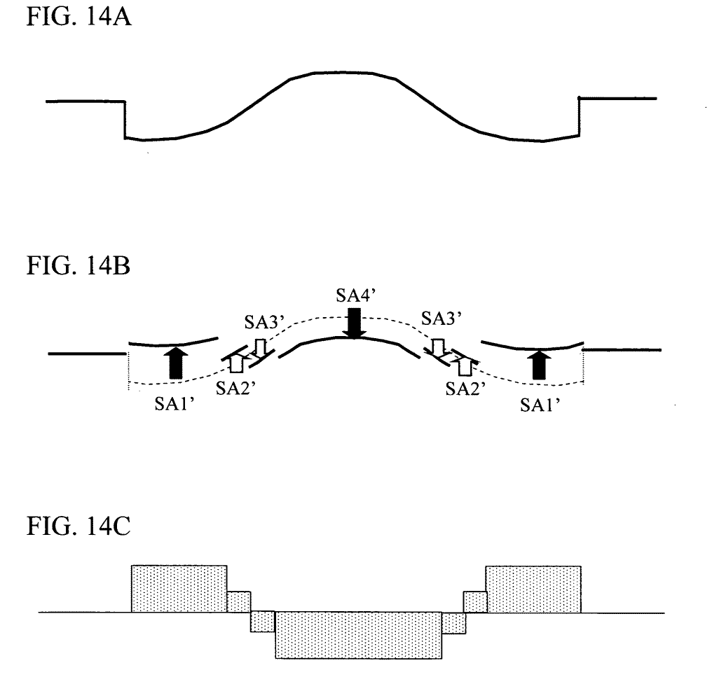

FIGS. 14A to 14C show a change in wavefront aberration shape when the liquid crystal drive circuit shown in FIG. 13 is used to apply a voltage to the aberration compensation element having a BD/HD compatible electrode shown in FIGS. 11A to 11C. FIG. 14A shows a wavefront aberration shape in the objective lens element unit 18 before aberration compensation; FIG. 14B shows a wavefront aberration shape in the objective lens element unit after aberration compensation; and FIG. 14C shows the amount of wavefront aberration of the objective lens element unit by the liquid crystal compensation element. Before compensation, in the outer peripheral portion of the refractive lens unit 18, since the area thereof is adjusted to the BD substrate thickness wavefront aberration does not occur, resulting in a flat shape. However, in the inner side of the lens unit, wavefront aberration occurs due to a substrate thickness error since the inner side thereof is adjusted to an intermediate substrate thickness between the BD and the HD. In the inner side of the lens unit, the polarity (sign) of the wavefront aberration is reversed. This is because for the optical disc, spherical aberration generated by a disc substrate thickness error and the like is corrected by an adjustment (defocus) in the optical axis direction of the lens. If the amount of spherical aberration is very small, the spherical aberration can be corrected only by the defocus. If a very large spherical aberration occurs like BD/HD compatibility, a very large wavefront aberration shape occurs as shown in FIG. 14A and recording and reproducing are difficult in the state before aberration compensation. When a voltage is applied to the individual concentric ring shaped electrode areas SA1′, SA2′, SA3′, and SA4′ of the aberration compensation element shown in FIGS. 11A to 11C, the wavefront aberration after passing through the refractive lens unit 18 is as shown in FIG. 14B, from which it is understood that spherical aberration is reduced as a whole. The liquid crystal sandwiched by the individual concentric ring shaped electrode can correct only a predetermined amount of spherical aberration, and thus the amount of spherical aberration is in a stepped state as shown in FIG. 14C.

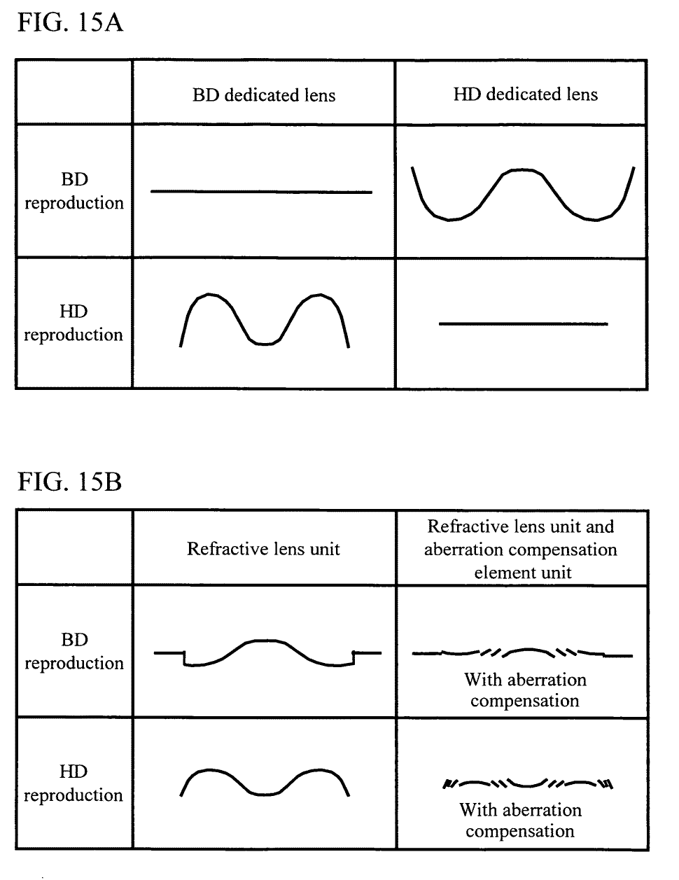

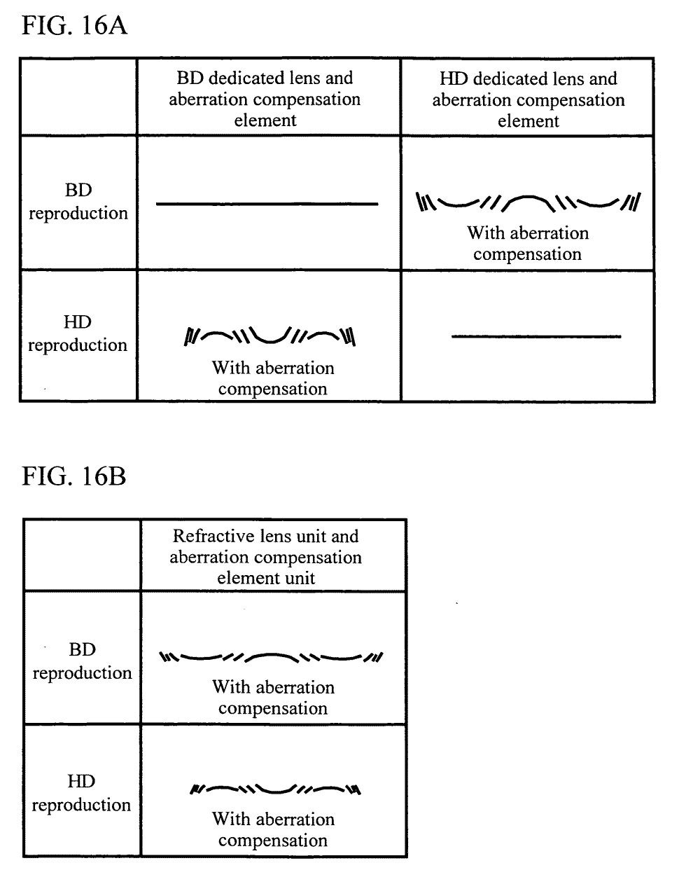

With reference to FIGS. 15A, 15B, 16A and 16B, spherical aberration compensation effects in accordance with the present embodiment are described. Here, an effect of compensation in accordance with the present embodiment for spherical aberration due to a substrate thickness error generated at layer switching of a BD/HD compatible optical disc, which is larger than at layer switching of a multilayer optical disc.

FIG. 15A shows spherical aberration shapes at reproduction of a BD and an HD by a conventional objective optical element; and FIG. 15B shows spherical aberration shapes at reproduction of a BD and an HD by the present invention. It should be noted that the conventional objective optical element refers to an objective lens having an NA of 0.85 for a BD reproduction and an objective lens having an NA of 0.65 for an HD reproduction. Replacing the objective lens with the aberration compensation objective optical element 24 shown in FIG. 12 can compare the spherical aberration of the conventional objective optical element and the spherical aberration of the aberration compensation objective optical element in accordance with the present invention. Here, the direction of a voltage applied to the liquid crystal in order to perform spherical aberration compensation at BD reproduction is assumed to be positive.

As shown in FIG. 15A, when a BD is reproduced by a BD dedicated lens and when an HD is reproduced by an HD dedicated lens, no spherical aberration occurs and the wavefront aberration shape is flat (showing nothing). When a BD and an HD are reproduced only by the objective lens unit in accordance with the present invention, as shown at left in FIG. 15B, wavefront aberration occurs in an area corresponding to an HD having a small NA, or a central portion of the lens for both the BD and the HD. It should be noted that the outer peripheral portion of the lens is designed only for a BD from the beginning, the wavefront aberration shape is flat only by the objective lens unit in accordance with the present invention. Next, when an HD is reproduced by a BD dedicated lens and when a BD is reproduced by an HD dedicated lens, as shown in FIG. 15A, spherical aberration occurs which is larger than that of the objective lens unit in accordance with the present invention shown at left in FIG. 15B and the wavefront aberration shape appears in a form of big waves. The present invention uses not only the objective lens unit, but also the aberration compensation element unit to correct spherical aberration and makes an adjustment so as to make the wavefront aberration shape as flat as possible for both the BD and the HD as shown at right in FIG. 15B. Specifically, this can be implemented by applying a positive voltage to the electrode of the aberration compensation element unit at BD reproduction and by applying a negative voltage thereto at HD reproduction.

Next, a comparison was made between the case where the aberration compensation element is used together with the individual dedicated lens and the case where the aberration compensation objective element of the present invention is used. As shown in FIG. 16A, when an HD is reproduced by a BD dedicated lens and when a BD is reproduced by an HD dedicated lens, the wavefront aberration shape is close to flat by the aberration compensation element. However, in comparison with the aberration compensation objective element of the present invention shown in FIG. 16B, the wavefront aberration shape is close to flat, but the magnitude thereof is larger than that of FIG. 16B. This is because in comparison with the objective lens unit of the present invention, the individual dedicated lens has a larger spherical aberration to be corrected to support a different substrate thickness. In view of the voltage applied to the liquid crystal element, this means an increase in the amount of voltage applied to the liquid crystal element having the same optical property. Accordingly, the present invention can provide spherical aberration compensation with a smaller amount of drive voltage and a higher accuracy than for the conventional technique.

In the present embodiment, when a two-layer BD disc is used and a maximum of 4V rms (AC) is applied to the aberration compensation element unit at BD reproduction in order to reproduce a layer at the surface-far side (substrate side) viewed from the light incidence side, the wavefront aberration can be reduced from a maximum of 1.5λ to 100 mλ at a lens unit or below ¼ compensation. Further, when the operation switch shown in FIG. 13 is turned on to apply a voltage to the multilayer BD aberration compensation element unit to reproduce a layer at the surface-near side viewed from the light incidence side, the spherical aberration can be reduced from 400 mλ to 75 mλ in RMS wavefront aberration amount or below ¼ compensation. In addition, when a single layer HD disc is used and −2V rms (AC) is applied to the aberration compensation element unit at BD/HD reproduction in order to reproduce the layer, the wavefront aberration can be reduced from a maximum of 1.0λ to 70 mλ at a lens unit or below ¼ compensation (at this time, the operation switch is off).

It should be noted that it is possible to increase the amount of reduction by increasing the liquid crystal layer thickness and the magnitude of the applied voltage. Further, a smaller pattern electrode can provide a higher accuracy, or can make the amount of wavefront aberration smaller than 0.2%. In addition, for a multilayer optical disc having two or more layers, it is possible to add an electrical circuit having a plurality of level outputs so as to control the amount of voltage applied to between the layers. Then, a switch is used to select from among the plurality of level outputs.

### Second Embodiment

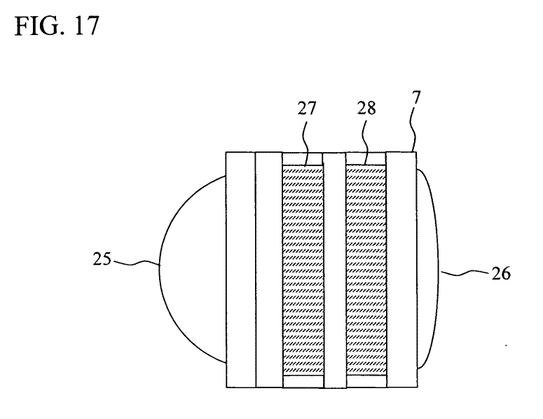

Next, with reference to FIGS. 17 to 20, a second embodiment of the present invention will be described.

FIG. 17 is a schematic view showing another example of the objective optical element in accordance with the present invention. In comparison with the configuration shown in FIG. 8, the objective optical element is different in an integral lens having a sandwich structure where the objective lens unit is separated into a combination objective lens unit 1 (25) and a combination objective lens unit 2 (26); and an aberration compensation element unit with electrode arrangement integrally including multilayer BD compensation and BD/HD compatibility (forward path) 27 and an aberration compensation element unit with electrode arrangement integrally including multilayer BD compensation and BD/HD compatibility (backward path) 28, and a ¼ wavelength plate 7 are sandwiched therebetween.

In the example shown in FIG. 8, the objective lens unit, the aberration compensation element units, and the ¼ wavelength plate are fixed individually by a lens holder, but in the present embodiment, the above elements are integrated in a single lens unit. The procedure will be described below. First, a plurality of the aberration compensation element unit with electrode arrangement integrally including multilayer BD compensation and BD/HD compatibility (forward path) 27 and the aberration compensation element unit with electrode arrangement integrally including multilayer BD compensation and BD/HD compatibility (backward path) 28 are arranged in a plane. Subsequently, a plurality of combination objective lens units 2 (26) are collectively formed on a glass plate on the surface of the aberration compensation element unit 28 by plastic molding (injection molding). The plastic molding is a method for manufacturing lens by injecting heat-molten plastic into a mold, cooling and hardening, which is very useful for mass production. On the contrary, it is difficult to use plastic in a lens having a high NA since plastic has a smaller refractive index than optical glass. However, the present embodiment can combine two combination objective lens units into a high NA lens and thus can make the part thereof with plastic. Then, the plurality of objective lens units are separated into an individual lens, which is attached to the combination objective lens unit 1 separately formed on a substrate by glass molding with ultraviolet curing resin. This is because positioning (adjustment) of the lens is considered.

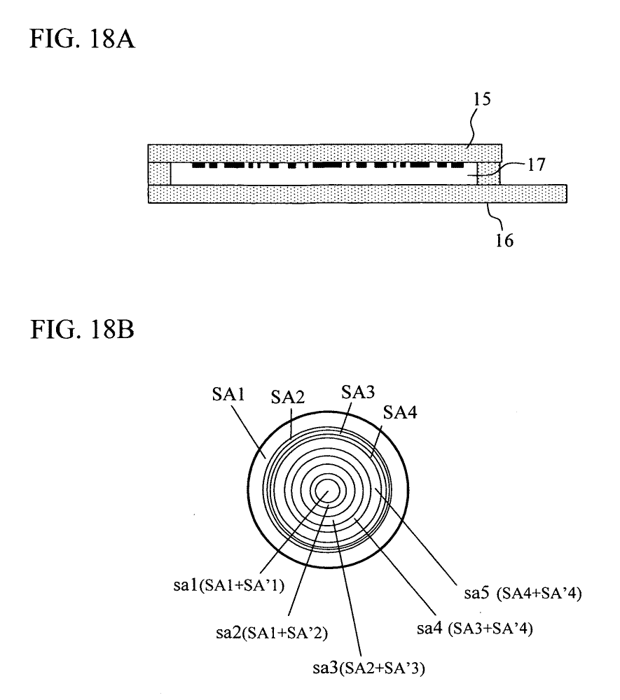

FIGS. 18A and 18B show a structure of the aberration compensation element unit. FIG. 18A is a schematic cross section of the aberration compensation element unit. FIG. 18B shows an arrangement of electrodes integrally including the multilayer BD compensation and the BD/HD compatibility. In comparison with the example shown in FIGS. 11A to 11C, the present embodiment is configured to arrange transparent electrodes which integrally include a concentric ring shaped pattern formed on the first substrate 15 to correct spherical aberration of a multilayer BD optical disc and a concentric ring shaped pattern to correct spherical aberration due to the difference in substrate thickness for BD/HD compatibility. The present embodiment simplifies the electrode pattern by removing the portion of too much narrow area among the superimposed concentric ring shaped patterns. This arrangement reduces the aberration compensation accuracy a little in comparison with the first embodiment, but increases yield at production in view of the aberration compensation element unit itself by reducing the number of pattern electrodes. This is because it is very important for the first embodiment to adjust the position of the first substrate 15 and the second substrate 16, but the present embodiment need not consider such positioning. The present embodiment can correct spherical aberration by applying a voltage of SA1, SA2, SA3, and SA4 as well as sa1, sa2, sa3, sa4, and sa5 to each area as shown in FIGS. 18A and 18B. Here, a newly used voltage of sa1, sa2, sa3, sa4, and sa5 can be expressed by using a voltage of SA1′, SA2′, SA3′, and SA4′ used in the first embodiment. The expression is given below.

sa1=SA1+SA1′

sa2=SA1+SA2′

sa3=SA2+SA3′

sa4=SA3+SA4′ (1)

sa5=SA4+SA4′

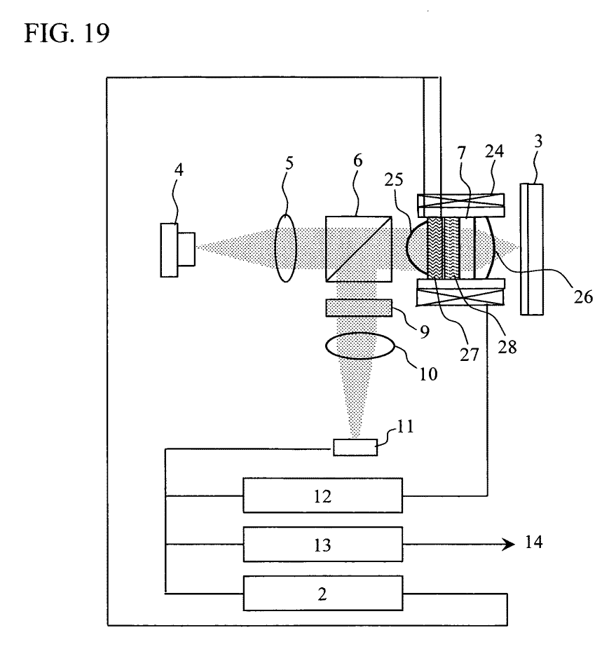

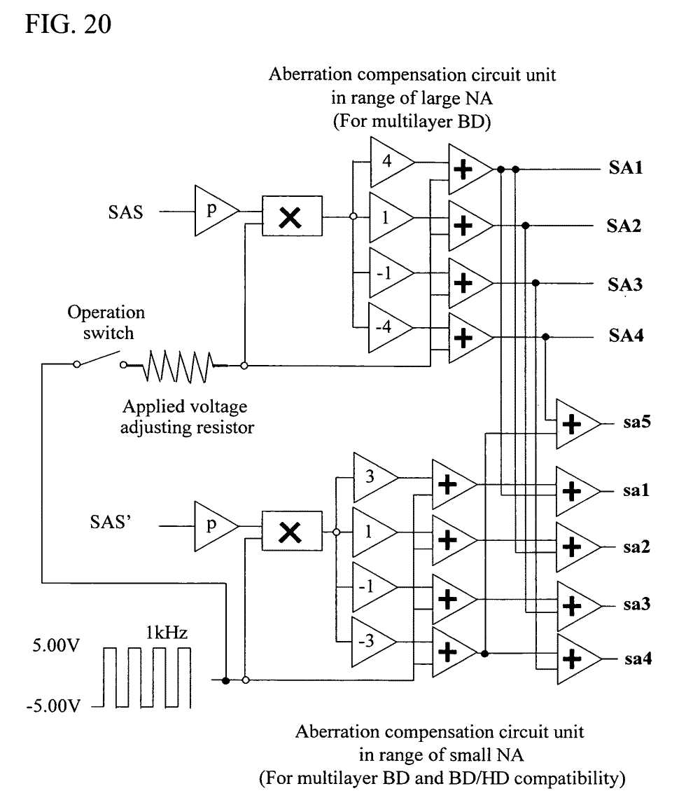

FIG. 19 shows an optical pickup apparatus in accordance with the present embodiment. In comparison with the configuration shown in FIG. 12, the optical pickup apparatus is different in structure of the objective optical element 24 as shown in FIG. 17, but is the same in structure of the other elements, and thus the detailed description is omitted. FIG. 20 is a schematic view showing a configuration of a liquid crystal drive circuit for the aberration compensation element unit in accordance with the present embodiment. The liquid crystal drive circuit is characterized by newly adding a plurality of adding circuits to satisfy the above expression (1).

In the present embodiment, a two-layer BD disc is used and when 3V rms (AC) is applied to the aberration compensation element unit in order to reproduce a layer at the surface-far side (substrate side) viewed from the light incidence side, the wavefront aberration can be reduced from a maximum of 1.5λ to 100 mλ at a lens unit or below ¼ compensation. Further, in order to reproduce a layer at the surface-near side viewed from the light incidence side, 4V rms (AC) is applied to the aberration compensation element unit, and when the operation switch in FIG. 20 is turned on to apply a voltage to the multilayer BD aberration compensation element unit, the spherical aberration can be reduced from 400 mλ to 100 mλ in RMS wavefront aberration amount or below ¼ compensation. In addition, a single layer HD disc is used and when −2V rms (AC) is applied to the aberration compensation element unit to reproduce the layer, the wavefront aberration can be reduced from a maximum of 1.0λ to 70 mλ at the lens unit or below ¼ compensation (at this time, the operation switch is off).

It should be noted that the present invention is not limited to the above embodiments, and constituent elements thereof can be modified and implemented in the execution phase without departing from the spirit and the scope of the present invention. In addition, various inventions can be made by combining the above embodiments and selecting an appropriate combination from among a plurality of components disclosed therein. Further, various inventions can be made by removing some constituent elements from all the components disclosed in the above embodiments.

What is claimed is:

1. An objective optical element for condensing laser light on a first optical information recording medium having a first substrate thickness with a first NA, and condensing the laser light on a second optical information recording medium having a second substrate thickness thicker than the first substrate thickness with a second NA smaller than the first NA,
comprising a refractive lens unit and an aberration compensation element unit;
wherein the refractive lens unit is designed such that an amount of RMS wavefront aberration is minimized with respect to a specific substrate thickness between the first substrate thickness and the second substrate thickness in the range of the second NA; and the RMS wavefront aberration is 0.05λ or less with respect to the first substrate thickness in an annular region outside the second NA and inside the first NA;
wherein the aberration compensation element unit has a structure in which a liquid crystal is sandwiched between a first transparent substrate and a second transparent substrate; at least the first transparent substrate is provided with a transparent electrode; and the transparent electrode has an electrode arrangement capable of correcting to ¼ or less the RMS wavefront aberration when the refractive lens unit condenses light on the first optical information recording medium and the second optical information recording medium by applying a voltage in the second NA range thereto.

2. The objective optical element according to claim 1, wherein the transparent electrode formed on the first transparent substrate is a concentric ring shaped pattern electrode formed in an area corresponding to the second NA.

3. The objective optical element according to claim 1, wherein a polarity of a voltage applied to the transparent electrode is reversed between the time when the laser light is condensed on the first optical information recording medium and the time when the laser light is condensed on the second optical information recording medium.

4. The objective optical element according to claim 1, wherein the first optical information recording medium is a Blu-ray Disc, and the second optical information recording medium is an HD DVD.

5. The objective optical element according to claim 1, wherein the specific substrate thickness d is greater than 85 μm and less than 600 μm.

6. The objective optical element according to claim 1, wherein the first optical information recording medium is a multilayer recording medium; the second transparent substrate of the aberration compensation element unit is provided with a transparent electrode; the transparent electrode has an electrode arrangement capable of correcting to ¼ or less the RMS wavefront aberration when the laser light is condensed on a layer other than a basic recording layer of the first optical information recording medium by applying a voltage in the first NA range.

7. The objective optical element according to claim 6, wherein the transparent electrode formed on the first transparent substrate is a concentric ring shaped pattern electrode formed in an area corresponding to the second NA, and the transparent electrode formed on the second transparent substrate is a concentric ring shaped pattern electrode formed in an area corresponding to the first NA.

8. The objective optical element according to claim 6, wherein when the laser light is condensed on a basic recording layer of the first optical information recording medium, a voltage is applied to a transparent electrode formed on the first transparent substrate; when the laser light is condensed on a layer other than the basic recording layer of the first optical information recording medium, a voltage is applied to the transparent electrode formed on the first transparent substrate and a transparent electrode formed on the second transparent substrate; and when the laser light is condensed on the second optical information recording medium, a voltage is applied to the transparent electrode formed on the first transparent substrate.

9. The objective optical element according to claim 1, wherein the first optical information recording medium is a multilayer recording medium; the transparent electrode formed on the first transparent substrate of the aberration compensation element unit has an electrode arrangement capable of correcting to ¼ or less the RMS wavefront aberration when the laser light is condensed on an individual recording layer of the first optical information recording medium in an area corresponding to the second NA, and the RMS wavefront aberration when the laser light is condensed on the second optical information recording medium by applying a voltage; and has an electrode arrangement capable of correcting to ¼ or less the RMS wavefront aberration when the laser light is condensed on an individual recording layer of the first optical information recording medium in an annular region corresponding to the outside of the second NA and the inside of the first NA by applying a voltage.

10. The objective optical element according to claim 9, wherein when the laser light is condensed on a basic recording layer of the first optical information recording medium, a voltage is applied to a transparent electrode formed in an area corresponding to the second NA; when the laser light is condensed on a layer other than a basic recording layer of the first optical information recording medium, a voltage is applied to a transparent electrode formed in an area corresponding to the second NA and a transparent electrode formed in the annular region; and when the laser light is condensed on the second optical information recording medium, a voltage is applied to a transparent electrode formed in the area corresponding to the second NA.

11. An optical head apparatus comprising a laser light source for emitting laser light; a objective optical element for condensing the laser light and performing spherical aberration compensation; and a control unit for controlling an amount of spherical aberration compensation by the objective optical element; and performing recording and reproducing by condensing laser light on a first optical information recording medium having a first substrate thickness with a first NA and condensing the laser light on a second optical information recording medium having a second substrate thickness thicker than the first substrate thickness with a second NA smaller than the first NA by the objective optical element;
wherein the objective optical element has a refractive lens unit and an aberration compensation element unit; the refractive lens unit is designed such that the amount of RMS wavefront aberration is minimized with respect to a specific substrate thickness between the first substrate thickness and the second substrate thickness in the range of the second NA; and the RMS wavefront aberration is 0.05λ or less with respect to the first substrate thickness in an annular region outside the second NA and inside the first NA; the aberration compensation element unit has a structure in which a liquid crystal is sandwiched between a first transparent substrate and a second transparent substrate; at least the first transparent substrate is provided with a transparent electrode; and the transparent electrode has an electrode arrangement capable of correcting to ¼ or less the RMS wavefront aberration when the refractive lens unit condenses light on the first optical information recording medium and the second optical information recording medium by applying a voltage in the range of the second NA.

12. The optical head apparatus according to claim 11, wherein the transparent electrode formed on the first transparent substrate is a concentric ring shaped pattern electrode formed in an area corresponding to the second NA.

13. The optical head apparatus according to claim 11, wherein a polarity of a voltage applied to the transparent electrode is reversed between the time when the laser light is condensed on the first optical information recording medium and the time when the laser light is condensed on the second optical information recording medium.

14. The optical head apparatus according to claim 11, wherein the first optical information recording medium is a Blu-ray Disc, and the second optical information recording medium is an HD DVD.

15. The optical head apparatus according to claim 11, wherein the specific substrate thickness d is greater than 85 μm and less than 600 μm.

16. The optical head apparatus according to claim 11, wherein the first optical information recording medium is a multilayer recording medium; the second transparent substrate of the aberration compensation element unit is provided with a transparent electrode; the transparent electrode has an electrode arrangement capable of correcting to ¼ or less the RMS wavefront aberration when the laser light is condensed on a layer other than a basic recording layer of the first optical information recording medium by applying a voltage in the first NA range.

17. The optical head apparatus according to claim 16, wherein the transparent electrode formed on the first transparent substrate is a concentric ring shaped pattern electrode formed in an area corresponding to the second NA, and the transparent electrode formed on the second transparent substrate is a concentric ring shaped pattern electrode formed in an area corresponding to the first NA.

18. The optical head apparatus according to claim 16, wherein when the laser light is condensed on a basic recording layer of the first optical information recording medium, a voltage is applied to a transparent electrode formed on the first transparent substrate; when the laser light is condensed on a layer other than a basic recording layer of the first optical information recording medium, a voltage is applied to a transparent electrode formed on the first transparent substrate and a transparent electrode formed on the second transparent substrate; and when the laser light is condensed on the second optical information recording medium, a voltage is applied to a transparent electrode formed on the first transparent substrate.

19. The optical head apparatus according to claim 11, wherein the first optical information recording medium is a multilayer recording medium; the transparent electrode formed on the first transparent substrate of the aberration compensation element unit has an electrode arrangement capable of correcting to ¼ or less the RMS wavefront aberration when the laser light is condensed on an individual recording layer of the first optical information recording medium in an area corresponding to the second NA, and the RMS wavefront aberration when the laser light is condensed on the second optical information recording medium by applying a voltage; and has an electrode arrangement capable of correcting to ¼ or less the RMS wavefront aberration when the laser light is condensed on an individual recording layer of the first optical information recording medium in an annular region corresponding to the outside of the second NA and the inside of the first NA by applying a voltage.

20. The optical head apparatus according to claim 19, wherein when the laser light is condensed on a basic recording layer of the first optical information recording medium, a voltage is applied to a transparent electrode formed in an area corresponding to the second NA; when the laser light is condensed on a layer other than a basic recording layer of the first optical information recording medium, a voltage is applied to a transparent electrode formed on an area corresponding to the second NA and a transparent electrode formed in the annular region; and when the laser light is condensed on the second optical information recording medium, a voltage is applied to a transparent electrode formed in the area corresponding to the second NA.
